(19) United States
(12) Patent Application Publication
(10) Pub. No.: US 2012/0018984 A1
(43) Pub. Date: Jan. 26, 2012

(54) INDEPENDENT DUAL WHEEL DIRECT DRIVE AXLES, BETWEEN THE DUALS GEAR BOX, AND INDEPENDENT SERVO DRIVE STEERING FOR BETWEEN THE DUAL DIRECT DRIVE SUSPENSIONS

(75) Inventor: Leo P. Oriet, Rochester Hills, MI (US)

(73) Assignee: NAVISTAR CANADA, INC., Warrenville, IL (US)

(21) Appl. No.: 13/097,304

(22) Filed: Apr. 29, 2011

Related U.S. Application Data
(63) Continuation-in-part of application No. PCT/US10/43091, filed on Jul. 23, 2010.

(51) Int. Cl. B60G 5/00; F16H 57/08; B60G 9/02

(52) U.S. Cl. 280/676; 280/124.11; 475/331

(57) ABSTRACT

A rear dual wheel direct drive axle assembly (30) for a vehicle having a longitudinal frame rail (28) includes a spindle shaft (1) attached to the frame rail and having an axis of rotation generally in the same vertical plane as the longitudinal frame rail. The assembly (30) also includes a dual wheel drive axle (13, 14) transversely and pivotally mounted on the spindle shaft (1). The axle (13, 14) is configured to pivot about the spindle shaft (1).

### BACKGROUND

Embodiments described herein relate to dual wheel direct drive axles, and particularly, to independently moveable dual wheel direct drive axles that are attached to vehicle frame rails.

Typically, truck, bus, coach, military and other commercial vehicles have a frame assembly formed of two longitudinal frame rails joined together with a plurality of cross members. The central portion of the frame is generally an open structure devoid of cross members, which allows the frame to twist longitudinally, providing torsional compliance as the vehicle traverses over uneven surfaces.

Rigid dual wheel drive axles are attached to a rear end of the frame rails using a variety of suspension systems. One or more drive axles are utilized to transfer the rotational energy generated by a conventional diesel engine into vehicular motion.

Although the conventional frame assembly is well balanced, equally spreading the load through the two frame rails, commercial vehicles are subjected to significant frame twisting in service. With the prior art frame assemblies, when the vehicle travels over an uneven surface, the suspension transfers the torsion into frame mounted parts such as fuel tanks, known as “fuel tank walking”, in which over the passage of time, the fuel tank moves along the frame rails commonly resulting in misalignment of a fuel fill tube with a fuel fill door. Other components that absorb the torsion are the rigid truck cab structure and the front hood, which due to the torsional absorption, can experience micro-fractures and hinge breakage in the field.

Further, under the torsional loading in the field, the frame rails can crack and/or split, and the transverse torque rods can break and/or be forced through the frame rail. When failures of this nature occur, the broken frame rails are repaired or replaced. Repairs often entail the complete disassembling of the frame assembly and cross members, cutting all huck bolts and then inserting a fabricated frame rail shaped such that it can be inserted along the inside surface of the previously broken rail. However, there is service downtime to repair and/or replace failed components, and the repaired/replaced frame assembly remains unable to absorb the longitudinal torsion.

Commercial vehicles having dual axles are steered by steerable front wheels. The turning radius of such vehicles depend on where the rigid front axle that contains the steerable front wheels is located in relation to the dual rear axle, and how far inboard and outboard the front wheels can be turned. A vehicle's turning radius determines how well it, and any trailer load it may be towing, can be maneuvered both in confined spaces, such as when backing a trailer into a loading/unloading dock, and when operating on winding roads having sharp turns. A vehicle's maneuverability may be a factor in a potential customer's decision to purchase it.

Additionally, there is interest in the industry to electrify commercial vehicles. The electrification of commercial vehicles provides new opportunities to incorporate alternative drivelines, steering systems and suspensions into commercial vehicles. However, even with the development of electrified commercial vehicles, the prior art frame assemblies do not address the issue of torsional loading.

### SUMMARY

A rear dual wheel direct drive axle assembly for a vehicle having a longitudinal frame rail includes a spindle shaft mounted to the frame rail and having an axis of rotation generally in the same vertical plane as the longitudinal frame rail. The assembly also includes a dual wheel drive axle transversely and pivotally mounted on the spindle shaft. The axle is configured to pivot about the spindle shaft.

Another rear dual wheel direct drive axle assembly for a vehicle having a longitudinal frame rail includes a spindle shaft mounted to the frame rail. The assembly also includes a dual wheel drive axle transversely mounted on the spindle shaft. A first wheel is mounted on the dual wheel drive axle and is located on a first side of the frame rail, and a second wheel is mounted on the dual wheel drive axle and is located on a second side of the frame rail.

A servo steering assembly for a dual axle includes a walking beam for suspending the dual axle from a vehicle chassis frame, where the dual axle includes a front axle at a front of the walking beam and a rear axle at a rear of the walking beam, where the front axle is independently rotatable from the rear axle. Both the front axle and the rear axle include a carrier carrying a direct wheel drive mechanism that includes an inboard wheel hub, an outboard wheel hub, and a drive motor disposed between the inboard wheel hub and the outboard wheel hub for rotating the inboard wheel hub and the outboard wheel hub. The assembly includes a front steering motor mounted on the walking beam and having a shaft coupled to the carrier of the front axle for steering the front axle of the dual axle to the right and to the left from a straight steering position. The assembly also includes a rear steering motor mounted on the walking beam and having a shaft coupled to the carrier of the rear axle for steering the rear axle of the right dual axle half to the right and to the left from the straight steering position.

A gear box having wheel hubs disposed at opposite ends of the gear box on a major axis includes two direct drive planetary gear sets. A motor casting is disposed between the two planetary gear sets. The motor casting has a pass-through hole that is generally transverse to the major axis and located generally at a center of gravity of the gear box for receiving a spindle shaft. The gear box also includes two direct drive motors disposed in the motor casting. Each of the direct drive motors is operatively coupled to the direct drive planetary gear set for independently driving the wheel hubs.

### BRIEF DESCRIPTION OF THE DRAWINGS

FIG. 1A is a schematic front view of a prior art conventional axle attached to frame rails.

FIG. 1B is a schematic front view of a prior art direct drive axle cantilevered from the frame rails.

FIG. 1C is an independent dual wheel direct drive axle attached to a centerline of frame rails.

FIG. 2 is a top view of the independent dual wheel direct drive axles attached to the centerline of the frame rail with a walking beam suspension.

FIG. 3 is a side elevation view of the independent dual wheel direct drive axles attached to the centerline of the frame rail with the walking beam suspension.

FIG. 4 is a front view of the gear box for the independent dual wheel direct drive axles.

FIG. 5 is an exploded schematic front view of the gear box for the independent dual wheel direct drive axles.

FIG. 6 is a top view of the independent dual wheel direct drive axles attached to a servo steering assembly of a walking beam for independent dual wheel direct drive air ride suspensions.

FIG. 7 is a side elevation view of the independent dual wheel direct drive axles attached to the servo steering assembly of a walking beam for independent dual wheel direct drive air ride suspensions.

FIG. 8 is a top view of a second embodiment of the independent dual wheel direct drive axles attached to servo steering assembly of a walking beam for independent dual wheel direct drive rigid mount suspensions.

FIG. 9 is a side elevation view of the second embodiment of the independent dual wheel direct drive axles attached to servo steering assembly of a walking beam for independent dual wheel direct drive rigid mount suspensions.

FIG. 10 is a schematic plan view of a representative vehicle platform.

### DETAILED DESCRIPTION

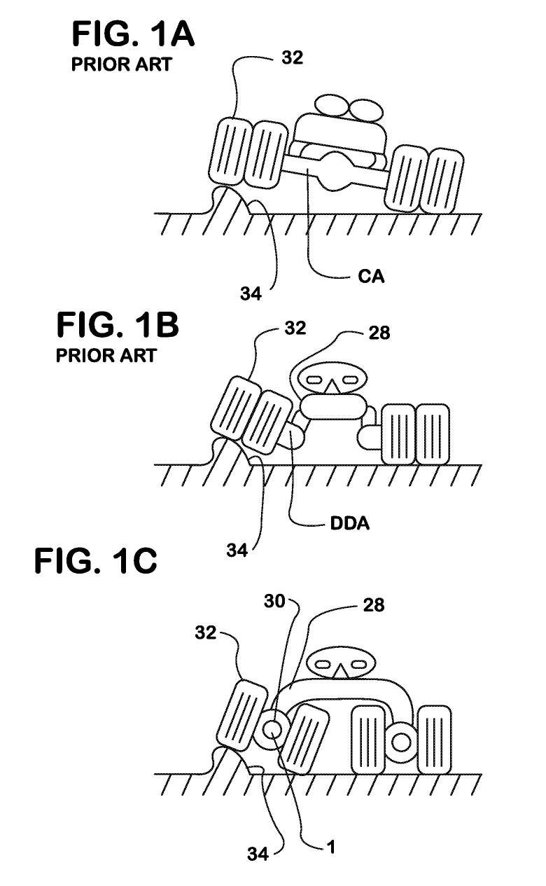

Referring to FIG. 1A, a conventional axle CA has wheels 32 attached to each end of the axle. When the conventional axle CA drives over an uneven driving surface 34, frame rails are subjected to torsional forces that can lead to frame failure.

Referring to FIG. 1B, a prior art direct drive axle DDA has wheels 32 cantilevered from a frame rail 28. The direct drive axle DDA in FIG. 1B is in a common failure mode. When the prior art direct drive axle DDA drives over an uneven driving surface 34, the torsional forces can lead to suspension failure. Additionally, tire failure can occur from the overloading of the outside tires when traversing over the uneven driving surface.

Referring now to FIG. 1C to FIG. 3, a rear dual wheel direct drive axle assembly (herein referred to as “direct drive assembly”) is generally indicated at 30, and is mounted to the frame rail 28. As shown in FIG. 1C, the direct drive assembly 30 is centered with the frame rail 28. When the direct drive assembly 30 drives over an uneven driving surface 34, the assembly independently oscillates with respect to the frame rail 28 so that the wheels 32 encountering the uneven driving surface can traverse the surface, while the wheels not encountering the uneven driving surface remain in contact with the driving surface.

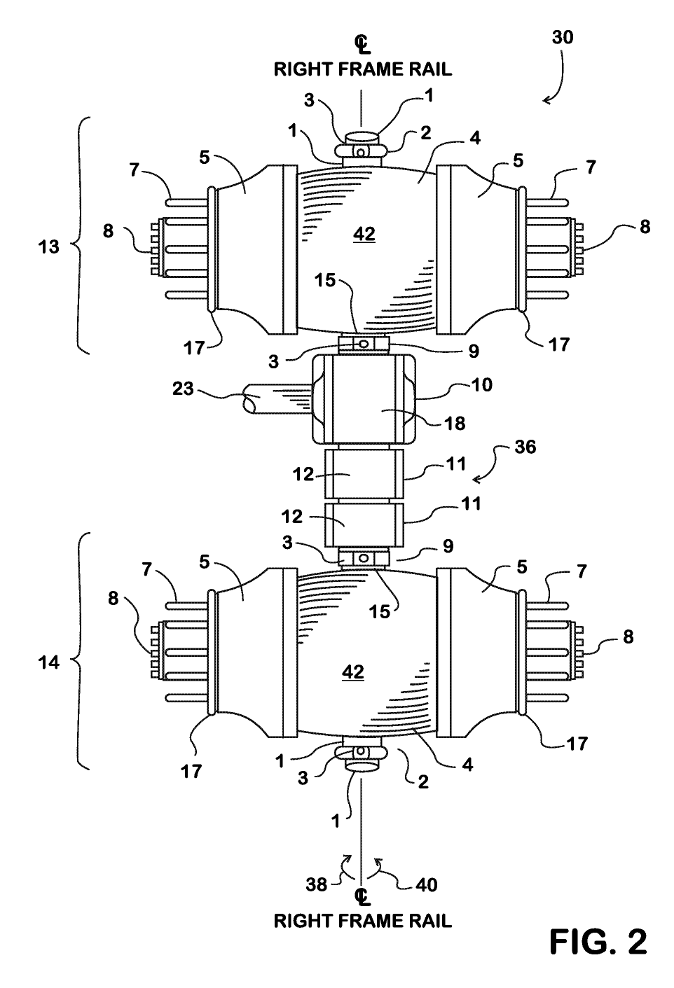

Referring now to FIG. 2, the direct drive assembly 30 may have a front dual wheel drive axle 13 and a rear dual wheel drive axle 14, however other numbers of axles are contemplated. The front drive axle 13 and the rear wheel axle 14 are mounted on a spindle shaft 1 that defines an axis of rotation for the oscillation of the front drive axle 13 independently from the rear wheel axle 14. Further, while the right frame rail 28 is shown in FIG. 2, it should be appreciated that a second direct drive axle assembly may be located on a left frame rail, having generally the mirror-image of the first drive assembly 30, which provides oscillation of the front and rear axles on the left side independently of the oscillation of the front and rear axles on the right side.

The axis of rotation and the centerline of the frame rail 28 are in the same vertical plane. The dual wheel drive assembly 30 pivots about the axis of rotation about 20-degrees from the vertical plane in a first direction 38, for example clockwise, and about 20-degrees from the vertical plane in a second direction 40, for example counterclockwise. In this configuration, a 9-inch obstacle can be traversed without transferring torsional forces to the spindle shaft axle 1 or to the tractor frame 28. For off-road applications, such as logging, mining and military applications, there can be up to about 25-degrees of oscillation. With 25-degrees of oscillation, an 11-inch obstacle can be traversed without transferring torsional forces to the spindle shaft axle 1 or to the tractor frame 28. The degree of oscillation may be adjustable between about 18 to 25-degrees. The degree of oscillation is limited by design considerations such as the wheel assembly 32 clearances relative to the frame rails 28, the loading on the vehicle, and whether the vehicle is a frame mounted body or a fifth wheel trailer. Mechanical stops, such as welded hard stop nuggets may be provided to adjust the range of oscillation.

The front dual wheel drive axle 13 and the rear dual wheel drive axle 14 both have a gear box 42 generally centrally disposed on the axle, and that is rotatably disposed on the spindle shaft 1. Each gear box has at least one internal direct drive motor 4, which may be electric or hydraulic high torque motors that oscillate with the axles 13, 14 about the spindle shaft 1, however other motors are possible. The direct drive motors 4 may also be of the motor/generator type that can recover energy during regenerative braking of a vehicle.

In the direction transverse to the spindle shaft 1, each gear box 42 may have wheel hub brake drums 5 on both transverse sides of the gear box. Extending from the brake drums 5 are wheel mount bolt plates 17 and a plurality of wheel nut studs 7 extending in the transverse direction to the spindle shaft 1 for receiving the wheels 32. A grease plate 8 may be disposed at each end of the front dual wheel drive axle 13 and the rear dual wheel drive axle 14.

The spindle shaft 1 also defines the sagittal plane or centerline of the direct drive assembly 30, which is located in the same vertical plane as the centerline of the frame rail 28. In this configuration, one wheel 32 of the front dual wheel drive axle 13 is disposed on one side of the frame rail 28, and the other wheel of the front dual wheel drive axle is disposed on the other side of the frame rail 28. Similarly, one wheel 32 of the rear dual wheel drive axle 14 is disposed on one side of the frame rail 28, and the other wheel of the rear dual wheel drive axle is disposed on the other side of the frame rail.

On the exterior side of the direct drive motor 4, the spindle shaft 1 may be threaded and have a small outside diameter, while on the interior side of the direct drive motor, the spindle shaft 15 may be threaded and have a larger outside diameter, however it is possible that the spindle shaft can have other configurations and diameters. A first lock nut 2 and lock pin 3 may be received at the exterior side of the spindle shaft 1, and a second lock nut 9 and pin 3 may be received at the interior side of the spindle shaft 1 to secure the gear boxes 42 and direct drive motors 4 onto the spindle shaft 1. Lock nut 9 also assists with pushing the drive motor 4 and sleeve bearing off the spindle shaft 1 in service.

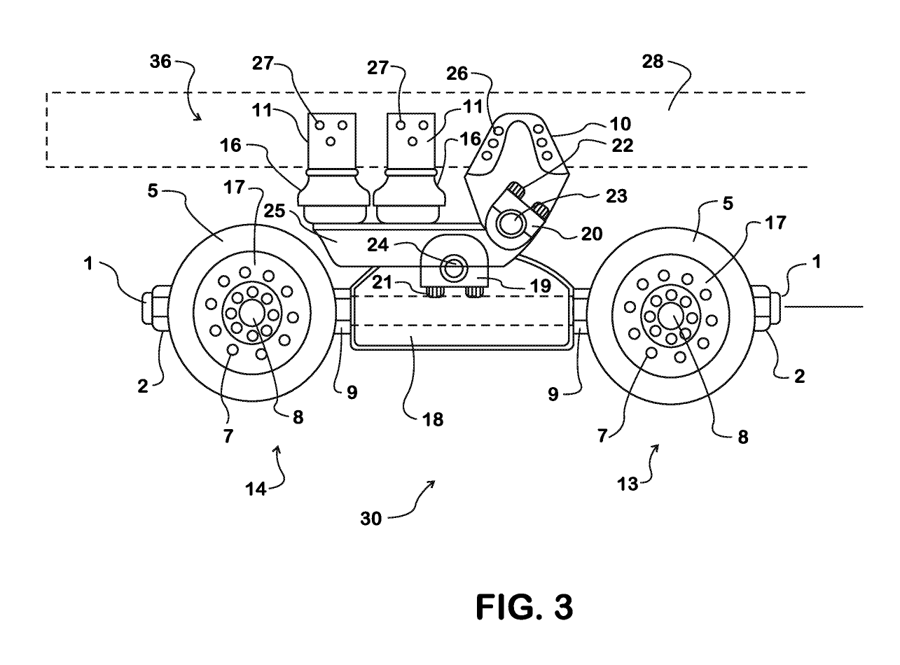

Referring now to FIG. 3, the direct drive assembly 30 is mounted to the frame rail 28 with a walking beam 18 and an air ride suspension 36 that receives the spindle shaft 1 between the front dual wheel drive axle 13 and the rear dual wheel drive axle 14. The spindle shaft 1 extends through the walking beam 18, and the spindle shaft 1 may be a hardened one-piece shaft that extends through direct drive axles 13, 14 and is fixed in the walking beam 18. The direct drive axles 13 and 14 may rotate about a lubricated sleeve bearing (not shown) about spindle shaft 1. Grease fittings may be used to lubricate the sleeve bearing (not shown).

The walking beam 18 is pivotally and captively attached to an air ride beam 25 clevis with two walking beam pin brackets 19 and a pin 24. Four fasteners 21 are used to clamp pin 24 between the air ride beam 25 and the two brackets 19. The walking beam 18 rotates about a lubricated sleeve bearing relative to a fixed 24 pin air ride beam assembly. Grease fittings are used to lubricate the walking beam 18 sleeve bearing (not shown). The air ride beam 25 may be pivotally attached to a suspension bracket 10 with two air ride brackets 20 and one pin 23. Four fasteners 22 may be used to clamp pin 23 between air ride beam 25 and two brackets 20. Air ride beam 25 is fixed to pin 23, and together this assembly rotates about a lubricated sleeve bearing (not shown) about suspension bracket 10. Grease fittings are used to lubricate the sleeve bearing. Huck bolts 26 or other fasteners are inserted into holes 27 to attach the suspension bracket 10 and the air bag brackets 11 to the frame rail 28.

Bolts 27 mount at least one air bag 16 on an air bag bracket 11 to the frame rail 28. In the suspension assembly of FIGS. 2 and 3, two air bags 16 are mounted on the frame rail 28, however other numbers are possible. Contacting the air ride beam 25, the air bags 16 of the air ride suspension 36, in conjunction with the walking beam 18, allow the wheels 32 to travel through about 17-inches of vertical roadway obstructions.

As shown in FIG. 1C, the direct drive assembly 30 addresses the torsional loading on the frame rails 28 by allowing the independent oscillation of the front and rear dual wheel drive axles 13, 14, as well as independent oscillation of the rear axles on the left frame rail and the right frame rail. Further, the direct drive assembly 30 provides stability, continuous road contact, and balanced tire load spread and traction. Further still, the direct drive assembly 30 is repairable and replaceable with common hand tools, potentially reducing vehicle service downtime.

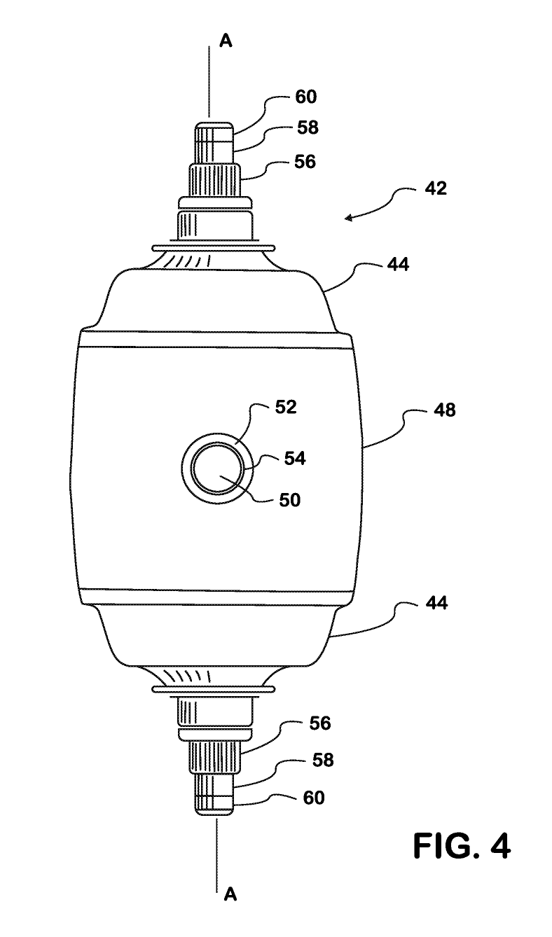

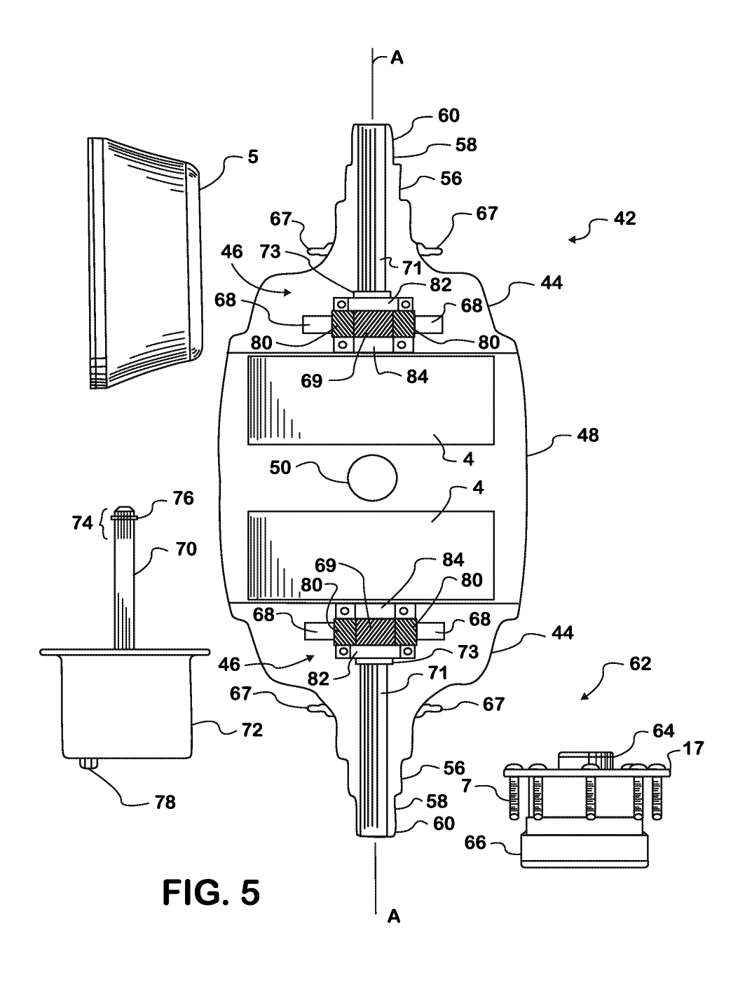

Referring now to FIGS. 4 and 5, a gear box 42 for independent oscillation between the dual wheel drive axles 13, 14 will be explained in more detail. The gear box 42 has a major axis A and includes two gear cases 44, each housing one direct drive planetary gear set 46 and an accompanying oil lubrication reservoir (not shown). Disposed between the two gear cases 44 is a motor casting 48, which may be a one-piece cast part that houses two direct drive motors 4. The direct drive motors 4 may be electric, hydraulic, or a hybrid of both.

The motor casting 48 also defines a pass-through hole 50 for the spindle shaft 1. The spindle shaft 1 extends through the gear box 42 generally at the center of gravity of the gear box, with or without the wheels 32 attached. For mating with the shaft lock nut 9 (FIG. 2), a machined surface 52 is disposed about the pass-through hole 50. Disposed between the pass-through hole 50 and the machined surface 52 may be a lubrication grease channel 54.

Extending outwardly along the longitudinal axis of the gear box 42 on each side of the gear case 44 is a planetary ring gear spline 56. Extending concentrically from the planetary ring gear spline 56 is a hub wheel bearing surface 58 and a threaded portion 60 for receiving and securing the hub wheel 62 onto the gear box 42.

A wheel hub ring gear and wheel stud plate assembly 62 includes a non-rotating female spline portion 64 that is fixed to the gear box 42 at the ring gear spline 56. Also non-rotating and fixed to the gear box is a wheel hub ring gear 66. Disposed between the non-rotating female spline portion 64 and the wheel hub ring gear 66 is the rotating wheel stud plate 17 having the at least one wheel studs 7 disposed concentrically about the wheel hub ring gear for receiving the wheel hub planetary gear set 72 and wheel W. A wheel hub brake drum 5 may be generally concentrically disposed over a portion of the gear case 44 and mounted with a brake mounting structure 67.

The gear box 42 provides dual planetary reductions for high torque applications, with the internal planetary reduction gear set 46 and an external wheel hub planetary reduction gear assembly 72. Extending from each direct drive motor 4 outwardly along the longitudinal axis of the gear box 42 is a non-rotating planetary ring gear 68 that is attached to the internal planetary reduction gear set 46, which confines four reaction carrier pinion gears 80 into constant mesh between ring gear 68 and the motor 4 output sun gear 69. Each planetary ring gear 68 includes four planetary pinions 80 disposed between a pinion carrier cage outer bearing 82 and a pinion carrier cage inner bearing 84. The reaction carrier which rotates with the pinion gears 80 has a central female spline 73 designed to mate up and lock in place the wheel hub planetary gear set input shaft 70, which is received in axle channel 71 in the gear case 44. An axle spline 74 and axle split ring 76 are received by the planetary reduction gear set 46 for transmitting the torque to the wheel hub planetary gear assembly 72. An oil fill plug 78 may allow oil lubrication of the hub planetary gear assembly 72.

The direct drive assembly 30 and the gear box 42 address the torsional loading on the frame rails 28 by allowing the independent oscillation of the front and rear dual wheel drive axles 13, 14, as well as independent oscillation of the rear axles on the left frame rail and the right frame rail. The gear box 42 allows the direct drive dual wheels axles to oscillate independently about 18 to 25 degrees from the vehicular sagittal plane. Further, the direct drive assembly 30 and the gear box 42 provide stability, continuous road contact, and balanced tire load spread and traction. The gear box 42 provides dual planetary reductions for high torque applications. Further still, the direct drive assembly 30 is repairable and replaceable with common hand tools, potentially reducing vehicle service downtime.

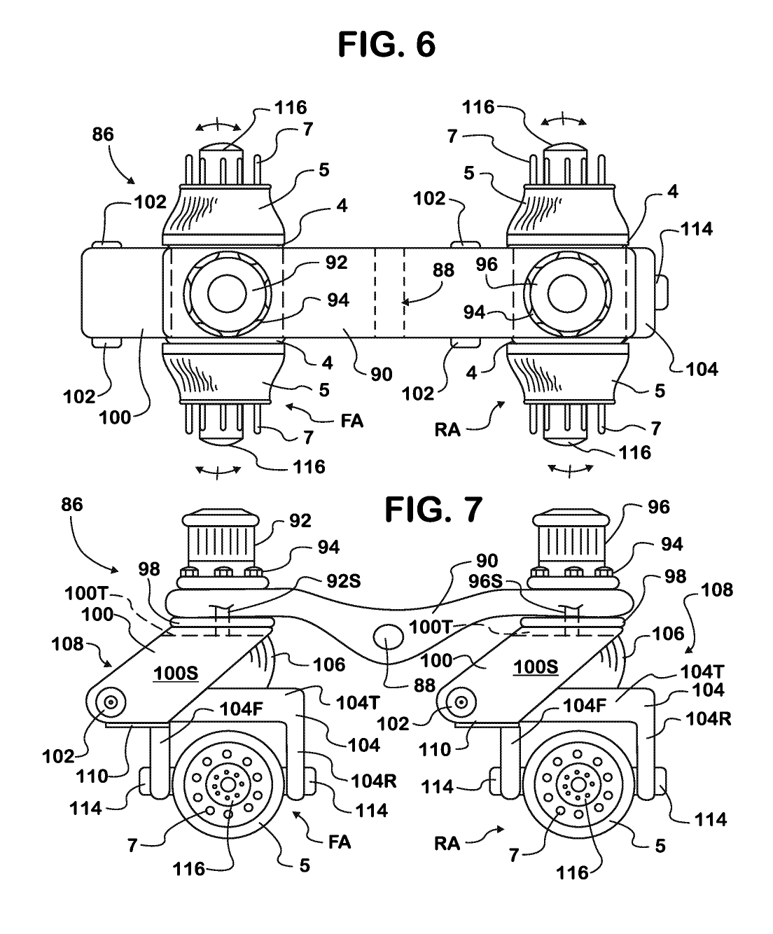

Referring now to FIGS. 6-10, a servo steering assembly for a dual axle DA is indicated generally at 86. The servo steering assembly 86 provides an all-wheel drive system in which both a front steering axle SA and the dual direct drive axles LDA, RDA are turned in response to operation of a steering wheel SW.

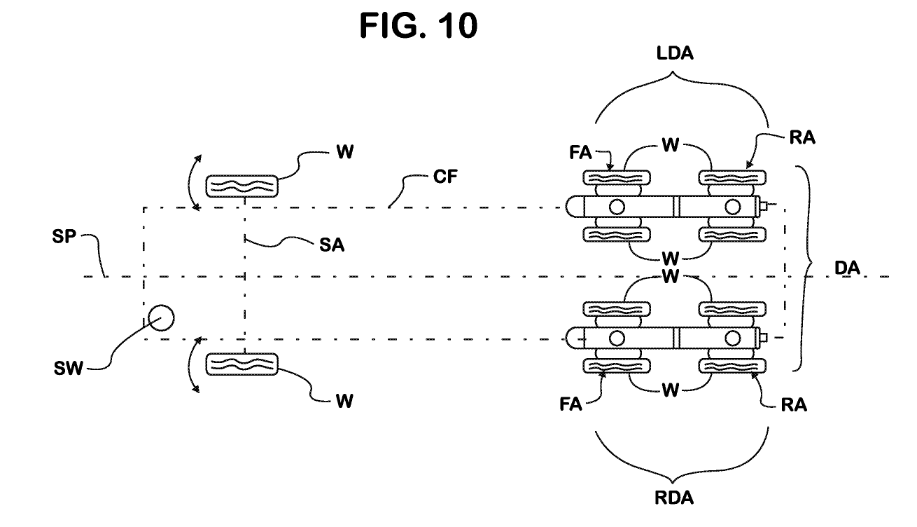

Referring to FIG. 10, the independent dual axle DA includes the right dual axle RDA that is located opposite the left dual axle LDA with respect to the sagittal plane SP of a truck vehicle platform having a chassis frame CF. The axle toward the left in FIGS. 6-9 is either the right half or the left half of a front axle FA of the dual axle DA, and the axle toward the right in FIGS. 6-9 is either the right half or the left half of a rear axle RA of the dual axle DA. In the vehicle platform shown in FIG. 10, a front steering axle SA that is forward of the dual axle DA comprises steerable front road wheels W independently driven by their own drive motors 4 (see FIGS. 6-9).

Referring now to FIGS. 6 and 7, a pin 88 is disposed centrally at the midpoint of each walking beam 90 between front axle FA and rear axle RA to provide a point of connection of the walking beam to the respective right or left side of the truck chassis frame CF either directly or through a suspension system. The suspension system of FIGS. 6 and 7 is an air ride suspension. A front hydraulic servo steering motor 92 is disposed on a flat area toward the front of a top surface of the walking beam 90 and is fastened to the walking beam by threaded fasteners 94. A rear hydraulic servo steering motor 96 is disposed on a flat area toward the rear of the top surface of walking beam 90 and is fastened to the walking beam by threaded fasteners 94.

Each hydraulic servo steering motor 92, 96 has a respective vertical shaft 92S, 96S that passes through a respective hole in the walking beam 90 and through a respective bearing 98 to attain a steering connection with a carrier 108. In the embodiment of FIGS. 6 and 7, the carrier is an air bag press assembly having a top wall 100T of a respective airbag press upper half 100. The servo steering motor 92, 96 is attached to the walking beam 90 with multiple fasteners 94. The steering connection enables each steering motor 92, 96 to steer each axle to the right or left from the straight steering position shown in FIGS. 6-10, with each axle being capable of being steered independently of the other.

In addition to the top wall 100T, each airbag press upper half 100 also has parallelogram-shaped sidewalls 100S (seen in FIG. 2) that extend horizontally forwardly and vertically downwardly from the top wall. Proximate the lower front corner of sidewalls 100S, a respective hinge pin 102 passes through one sidewall 100S, then a top wall 104T of a respective airbag press lower half 104, and then the opposite sidewall 100S. A respective airbag 106 is disposed between the top wall 100T of the respective airbag press upper half 100 and the top wall 104T of the respective airbag press lower half 104, forming the airbag press assembly 108. The airbag press assembly 108 rotates with the rotation of the vertical shaft 92S, 96S for steering each axle to the right or to the left from the straight steering position.

The airbag press assembly 108 hinges each airbag press lower half 104 for swinging motion about the axis of the respective hinge pin 102 with an airbag 106 captured between the two halves of the press to provide pneumatic damping of motion of each airbag press lower half toward the respective airbag press upper half. FIGS. 6 and 7 show a respective hard stop 110 mounted on each airbag press lower half 104 abutting a lower edge of the respective sidewall 100S to establish a limit to which the airbag press lower half 104 can compress the respective air bag. It should therefore be understood that when dual axle DA is functional in a truck vehicle, the airbag press halves are typically more open than shown in FIG. 2 to allow the airbags to be effective.

With the hinged connection of each airbag press lower half 104 to its upper half 100, the airbag assembly 108 will rotate about the axis of the respective shaft 92S, 96S when the respective servo steering motors 92, 96 operate. Each airbag press lower half 104 also comprises a respective front wall 104F spaced rearward of its hinge pin 102 and extending vertically downward from its top wall 104T and a respective rear wall 104R extending vertically downward at the rear of its top wall 104T. Front wall 104F, rear wall 104R, and the portion of top wall 104T between the two vertical walls cooperatively define a channel 112 having a downwardly open throat.

A respective drive motor oscillator shaft 114 has shaft ends journaled in walls 104F and 104R of the respective airbag press lower half 104 at locations that are below top wall 104T and that render shaft 114 parallel with top wall 104T. Each shaft 114 is thereby supported for oscillation about its own axis by front wall 104F and rear wall 104R. Each oscillator shaft 114 supports the respective direct drive motor 4 from the respective airbag press lower half 104 for concurrent oscillation with the oscillator shaft about the shaft's axis that passes centrally through a housing of a respective direct drive motor 4. Alternately, the ends of oscillator shaft 114 may be affixed to walls 104F and 104R with the shaft journaling the housing of the direct drive motor 4 for turning on the shaft.

Each direct drive motor 4 has a respective axle driveshaft 116 that comprises an inboard driveshaft portion and an outboard driveshaft portion. The inboard driveshaft portion extends inboard from the drive motor housing, and the outboard drive shaft portion extends outboard from the drive motor housing. Each inboard drive shaft portion is coupled to an inboard wheel hub 5, and each outboard drive shaft portion is coupled to an outboard wheel hub 5. In this configuration, each direct drive motor 4 is a “between-the-duals” direct drive for the road wheels that it directly drives. Further, each servo steering motor 92, 96, and the inboard and outboard wheel hubs 5 that it drives, form a respective direct wheel drive mechanism that is carried by the respective airbag press assembly via oscillator shaft 114. The direct drive motors 4 can be independently operated, allowing either, both, or neither to propel the vehicle at any given time with each axle FA, RA being independently suspended from its walking beam 90 and being independently steerable with the servo steering motor 92, 96.

Spiders of road wheels W (FIG. 10) are disposed against open faces of, fastened to, wheel hubs 5 by tightening wheel nuts (not shown) into wheel studs 7 that extend from hubs 5 through holes in the wheel spiders.

Collectively, each drive motor 92, 96 and the inboard and outboard wheel hubs 5 that it drives form a respective direct wheel drive mechanism that is carried by the respective airbag press assembly via oscillator shaft 114.

Use of the descriptor “direct” in reference to a direct drive motor and a direct wheel drive mechanism is not meant to imply that the inboard and outboard wheel hubs 5 of an axle must always rotate at the same speed because a single axle 116 extends through the direct drive motor to both wheel hubs. For example a direct wheel drive mechanism may comprises separate inboard and outboard shafts each operated by the same drive motor but turning at slightly different speeds when the axle is being steered to the right or the left due to suitable mechanisms incorporated between the drive motor and the separate shafts or due to a construction for the drive motor that accomplishes the same.

Each front axle FA can swing along an upward arc about the axis of pin 88 while the rear axle RA is swinging along a downward arc about the axis of pin 88, and each rear axle RA can swing along an upward arc about the axis of pin 88 while the front axle FA is swinging along a downward arc about the axis of pin 88. By making the distance between front axle FA and the axis of pin 88 equal to the distance between rear axle RA and the axis of pin 88 (as shown in FIGS. 1 and 2), the walking beam 90 functions as an equalizing beam because each axle will swing along a respective arc lying on a common circle. By arranging the axis of each oscillator shaft 114 to pass centrally through the housing of the respective direct drive motor 4 equidistant from the dual road wheels that it drives, those road wheels will swing up and down along arcs of a common circle.

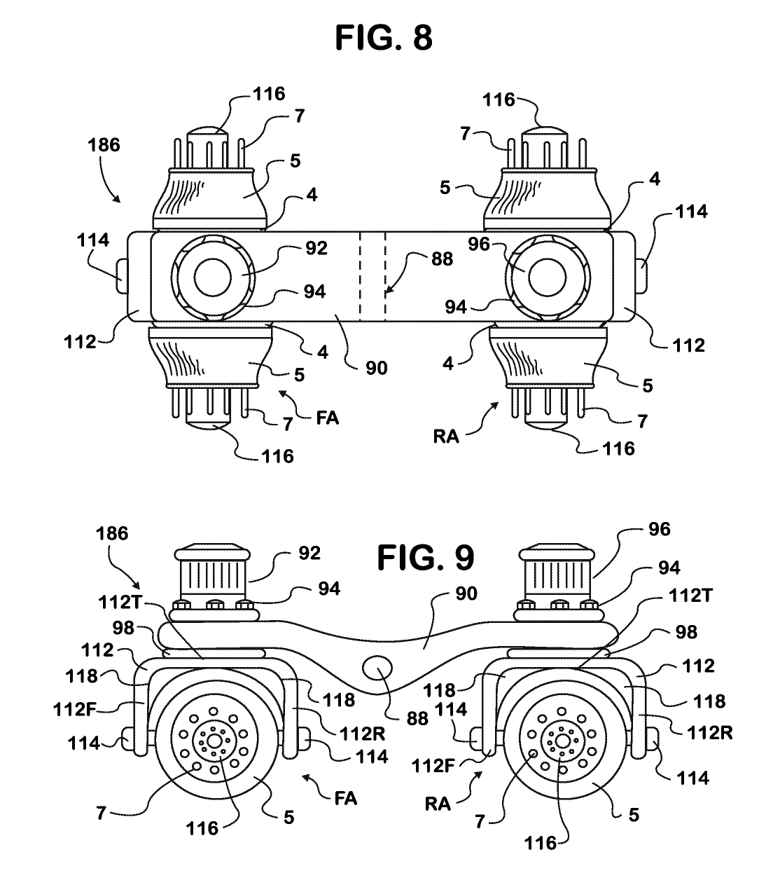

FIGS. 8 and 9 depict a second embodiment of servo steering assembly 186 for the dual axle DA having a rigid mount suspension. The components in FIGS. 8 and 9 are numbered with the same reference numbers as the common components in embodiment of FIGS. 6 and 7. In the embodiment of FIGS. 8 and 9, the shaft 92S, 96S of each steering motor 92, 96 has a steering connection with a carrier 112. The carrier 112 is a channel having a top wall 112T and front and rear vertical walls 112F, 12R forming a downwardly open throat. The channel 112 includes gussets 118 at the bends between top wall 112T and vertical walls 112F, 112R. Bearings 98 serve to separate the walking beam 90 from immediately underlying components while bearing load force between them to facilitate axle steering by motors 92, 96. Each axle FA, RA in FIGS. 8 and 9 is independently steerable on walking beam 90, each axle can be independently operated to propel the vehicle, and each axle can independently oscillate about the axis of its oscillator shaft 114.

In the disclosed embodiments, the various motors may be electric, hydraulic, or combinations thereof. They may be controlled by a comprehensive electronic control strategy suited for the particular vehicle to navigate various on-road and off-road surfaces. The disclosed embodiments provide an all-wheel steer walking beam 90 vehicle in which steering is accomplished with the aid of a computer-processor-controlled hydraulic or electric servo steering assembly 86, 186 that performs precise all-wheel vehicle steering front-to-back with high articulation walking beam suspensions. Wheels on each common axle can be steered independently and over ranges for enabling commercial and military vehicles to have near-zero turning radii for negotiating sharp roadway curves and tractor-trailer backing.

What is claimed is:

1. A rear dual wheel direct drive axle assembly for a vehicle having a longitudinal frame rail, comprising:
a spindle shaft mounted to the frame rail and having an axis of rotation generally in the same vertical plane as the longitudinal frame rail; and
a dual wheel drive axle transversely and pivotally mounted on the spindle shaft, wherein the axle is configured to pivot about the spindle shaft.

2. The rear dual wheel direct drive axle assembly of claim 1 wherein the dual wheel drive axle pivots about 20-degrees from the vertical plane in a first direction, and pivots about 20-degrees from the vertical plane in a second direction.

3. The rear dual wheel direct drive axle assembly of claim 1 further comprising a first wheel on the dual wheel drive axle on a first side of the frame rail, and a second wheel on a second side of the frame rail.

4. The rear dual wheel direct drive axle assembly of claim 3 further comprising a second dual wheel drive axle rotatably mounted on the spindle shaft, the second dual wheel drive axle having a third wheel on the first side of the frame rail, and a fourth wheel on a second side of the frame rail.

5. The rear dual wheel direct drive axle assembly of claim 1 further comprising a second dual wheel drive axle rotatably mounted on the spindle shaft, wherein the dual wheel drive axle and the second dual wheel drive axle are independently rotatable on the spindle shaft with respect to each other.

6. The rear dual wheel direct drive axle assembly of claim 5 further comprising a walking beam disposed between the dual wheel drive axle and the second dual wheel drive axle.

7. The rear dual wheel direct drive axle assembly of claim 6 further comprising an air suspension mounted to the frame rail and disposed between the frame rail and the walking beam.

8. The rear dual wheel direct drive axle assembly of claim 1 wherein the dual wheel drive axle is pivotal over an adjustable range of pivoting oscillation, wherein the range of pivoting is about 18 to 25-degrees from the vertical plane in a first direction, and about 18 to 25-degrees from the vertical plane in a second direction.

9. A dual wheel direct drive axle assembly for a vehicle having a longitudinal frame rail, comprising:
a spindle shaft mounted to the frame rail;
a dual wheel drive axle transversely mounted on the spindle shaft;
a first wheel mounted on the dual wheel drive axle and located on a first side of the frame rail; and
a second wheel mounted on the dual wheel drive axle and located on a second side of the frame rail.

10. The dual wheel direct drive axle assembly of claim 9 wherein the dual wheel drive axle is pivotal over an adjustable range of pivoting oscillation, wherein the range of pivoting is about 18 to 25-degrees from the vertical plane in a first direction, and about 18 to 25-degrees from the vertical plane in a second direction.

11. The dual wheel direct drive axle assembly of claim 9 further comprising a second dual wheel drive axle rotatably mounted on the spindle shaft, the second dual wheel drive axle having a third wheel on the first side of the frame rail, and a fourth wheel on a second side of the frame rail.

12. The rear dual wheel direct drive axle assembly of claim 9 further comprising a second dual wheel drive axle rotatably mounted on the spindle shaft, wherein the dual wheel drive axle and the second dual wheel drive axle are independently rotatable on the spindle shaft with respect to each other.

13. The rear dual wheel direct drive axle assembly of claim 11 further comprising a walking beam disposed between the dual wheel drive axle and the second dual wheel drive axle.

14. The rear dual wheel direct drive axle assembly of claim 13 further comprising an air suspension mounted to the frame rail and disposed between the frame rail and the walking beam.

15. A servo steering assembly for a dual axle comprising:
a walking beam for suspending the dual axle from a vehicle chassis frame, the dual axle comprising a front axle at a front of the walking beam and a rear axle at a rear of the walking beam, wherein the front axle is independently rotatable from the rear axle;
each of the front axle and the rear axle comprising a carrier carrying a direct wheel drive mechanism that comprises an inboard wheel hub, an outboard wheel hub, and a drive motor disposed between the inboard wheel hub and the outboard wheel hub for rotating the inboard wheel hub and the outboard wheel hub;
a front steering motor mounted on the walking beam and having a shaft coupled to the carrier of the front axle of the dual axle for steering the front axle to the right and to the left from a straight steering position; and
a rear steering motor mounted on the walking beam and having a shaft coupled to the carrier of the rear axle of the dual axle for steering the rear axle to the right and to the left from the straight steering position.

16. The dual axle as set forth in claim 15 in which each carrier comprises a channel having a top wall and sidewalls that extend downward from the channel's top wall and are spaced apart front-to-rear and, and in which each carrier carries its direct wheel drive mechanism by an oscillator shaft that extends between the channel's sidewalls below the channel's top wall, that allows the inboard wheel hub to swing upward along an arc while the outboard wheel hub swings downward along an arc, and that allows the outboard wheel hub to swing upward along an arc while the inboard wheel hub swings downward along an arc.

17. The dual axle as set forth in claim 15 in which each carrier comprises an airbag press having a press upper half, a press lower half, and a hinge that hinges the press upper half and the press lower half together frontally of the shaft of the respective steering motor to allow the press upper half and the press lower half to swing toward and away from each other, and further comprising a respective airbag disposed between each press upper half and the respective press lower half for providing pneumatic damping of motion each press lower half toward the respective press upper half.

18. The dual axle as set forth in claim 17 in which each press lower half comprises a channel having a top wall and sidewalls that extend downward from the top wall and are spaced apart front-to-rear, and in which each direct wheel drive mechanism is carried by an oscillator shaft that extends between the sidewalls below the top wall that allows the inboard wheel hub to swing upward along an arc while the outboard wheel hub swings downward along an arc, and that allows the outboard wheel hub to swing upward along an arc while the inboard wheel hub swings downward along an arc.

19. The dual axle as set forth in claim 18 in which each press upper half comprises a top wall spaced vertically above the top wall of the respective lower press half top wall, the respective airbag is disposed between the top wall of the respective upper press half and the top wall of the respective lower press half, and the shaft of each steering motor is coupled to the top wall of the respective press upper half.

20. A gear box having wheel hubs disposed at opposite ends of the gear box on a major axis, the gear box comprising:
two direct drive planetary gear sets;
a motor casting disposed between the two planetary gear sets, the motor casting having a pass-through hole generally transverse to the major axis and located generally at a center of gravity of the gear box for receiving a spindle shaft; and
two direct drive motors disposed in the motor casting, each direct drive motor operatively coupled to the direct drive planetary gear set for independently driving the wheel hubs.
